(19) United States
(12) Patent Application Publication
(10) Pub. No.: US 2008/0262940 A1
(43) Pub. Date: Oct. 23, 2008

(54) Purchase Order and Invoice Aggregator System for Sales Environment

(75) Inventor: Stephen C. Kovach, Rockwell, NC (US)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: TSC Group, Charlotte, NC (US)

(21) Appl. No.: 12/057,677

(22) Filed: Mar. 28, 2008

Related U.S. Application Data
(60) Provisional application No. 60/908,724, filed on Mar. 29, 2007.

(51) Int. Cl. G06Q 10/00; G06Q 30/00

(52) U.S. Cl. 705/26; 705/34

(57) ABSTRACT

A computerized system and method of aggregating sales data for delivery to a particular market participant includes a computer program designed to sort purchase order records and associated invoice records independently of any particular computer accounting system. The computer program receives sales data in the form of batch purchase order records or batch invoice records from a multitude of retailers and suppliers. The program converts the sales data into a standardized format that is independent of the computer systems used by the retailers and the wholesalers. The data conversion occurs outside the associated computer accounting systems as well. After converting the sales data, the system identifies which market participant, whether retailer or supplier, should receive each record and aggregates the appropriate records for transmission to the appropriate market participant. The system receives data in any arrangement and transmits data to any market participant in that participant's desired format.

### BACKGROUND OF THE INVENTION

The invention is a system of computer programs and the associated method of converting incoming or outgoing sales-related datasets to the preferred format for an appropriate destination, usually a merchandise supplier or a retailer. The system accepts data in any format the supplier or retailer prefers to use in its own operations and processes that data independently of any particular computer accounting system or underlying database. Built around the core of a typical Computer Accounting System (hereafter referred to as a “CAS”), these programs operate independently, as translators so to speak, bringing “supplier-to-retailer” and “retailer-to-supplier” data together. This frees both retailer and supplier from the tasks of customizing and altering existing business practices to move products from the original manufacturer to the consumer.

Over the last several decades, vendors in the marketplace have dealt with purchase orders and invoices in either paper or electronic format for goods and services. Unfortunately, no two vendors use identical terms or processes for ensuring that merchandise or services are made available to the vendor, accounted for in the books, and invoiced appropriately. Today, most market participants use electronic forms to transmit orders and invoices back and forth, but compatibility issues remain to be addressed. For example, a retailer has a computer system that demands that information be passed to it in a fixed format. That format could be one of several industry standards that are available, but most use Electronic Data Interchange (“EDI”). It is, however, at the discretion of the retailer to choose the most desirable format. The wholesaler/supplier delivering goods to the retailer has the same decisions regarding its internal business practices on the other side of the transaction. At some point, the retailer and the supplier must make arrangements for compatible data sets to flow back and forth. For example, if a wholesaler wants to sell products to a large retailer, that wholesaler may have to modify its current system to meet the retailer's specifications. In addition to that, if the retailer changes the requirements, the wholesaler will be required to modify its system accordingly or risk losing that retailer's business.

Given that the more powerful retailers often place strict demands on suppliers to comply with the retailer's system requirements, the supplier, or wholesaler, is forced to comply with the data formatting demands of every retailer receiving its goods. For example, Wal-Mart® might prefer its invoices in an EDI 4060 format and sent via AS2 transport methods. Kmart®, on the other hand, prefers the invoices in an EDI 4030 format and sent via a VAN (Value Added Network) called IBMNet. Target®, Radio Shack®, and others have their own proprietary formats and transports that the supplier/wholesaler must use. Suppliers must figure out a way to move their products to all of these different retailers and conform to each respective data format for ordering and invoicing.

Data formatting issues add significant overhead to the supplier in the sales chain, because the supplier usually complies with retailer data demands by hiring technical staff to work in-house, paying an outside consultant, or both. In addition to the data formatting issues for purchase orders from a retailer, the supplier/wholesaler must deal with accounts receivable from several retailers and invoice the retailers according to each retailer's preferred format. This dictates additional clerical staff for completing the transfers.

Prior patents and publications in the field of retail supply and demand chain management fail to fully address the issues encountered by suppliers, retailers, and any other middlemen in the sales process. Certain documents have brought up an overall need to resolve data formatting issues between suppliers and retailers, but none has addressed the additional accounting issues and other global problems discussed herein.

For example, U.S. Pat. No. 5,557,780 (Edwards 1996) shows a system that allows all data transmitted between retailers and suppliers to be available on both ends, even if the data is in a non-standard format. The Edwards '780 document focuses on finding an EDI template that best fits the data at hand, even if the data is not in ideal EDI format. Edwards further allows for ill-fitting data to be preserved in a catch-all area if the data does not fit into any field within the selected template. According to the Edwards '780 patent, EDI techniques can be used on both ends of a data transmission between retailers and suppliers to ensure that no data is lost. Edwards, however, is limited in its requirement that at least some EDI template must be used, even if the data is not formatted for EDI.

Similarly, international patent application WO 0043903 (Corkill 2000) discloses a computer implemented method of performing electronic data interchange between trading partners. The Corkill disclosure attempts to correct data formatting problems between retailers and suppliers but continues to require extensive processing in an EDI format on both ends of the transaction, i.e., the retailer and the supplier must both use some form of the EDI protocol for the Corkill system to be useful. This does not account for situations in which one of the trading partners is not on an EDI system.

Another international patent application, WO 0184434 (Cruse et al. 2001), also provides a centralized station for correcting data formatting issues between retailers and suppliers. The Cruse patent application, however, still requires certain standardized database entries on both ends of the transaction. If one of the trading partners does not have a system that is compatible with the other's database, then the method disclosed in the Cruse patent application is of no use.

In regard to software for data connectivity, U.S. Pat. No. 7,325,027 (Grow 2008) discloses a transformation and exchange gateway stored in computer memory. The transformation portion of the Grow '027 product includes numerous inbound data templates for manipulating the data from a first market participant and restructuring the data for transmission to a second market participant. Grow, however, fails to provide any solution to the problems present in the retail/supplier marketplace by which each side of the transaction sends information that must not only be re-formatted for receipt by the other side, but also sorted so that multiple recipients receive one transmission each of the proper information.

Similarly to the Grow '027 patent, U.S. Patent Application Publication No. 20070112579 (Ratnakaran 2007) provides a market management system that translates inbound and outbound data according to a defined set of business rules. The Ratnakaran '027 publication, however, is predominantly focused on the utilities industry and trading partners therein. The Ratnakaran solution continues the trend of individualized data transmissions including information that will ultimately be sent to only one intended recipient.

Accordingly, a need still exists in sales environments to provide data formatting services for purchase orders and invoicing in a manner that allows all trading partners to use their own respective computer systems. Particularly, in retail supply and demand chains, a need exists for a system that will accept purchase orders in any format and in any order. The system of this invention, forwards the orders to a supplier in whatever preferred format the supplier selects. Similarly, a need exists for a supplier to send out invoice records in any chosen format and have those records reformatted and sorted for use by a retailer's preferred system.

### SUMMARY DISCLOSURE OF THE INVENTION

The invention herein meets the need in the industry by providing a data formatting engine to be used in a sales environment and allowing trading partners with disparate electronic data formats to seamlessly exchange data regarding merchandise or services. The data may be purchase orders from a retailer looking to restock shelves or an invoice from a wholesale distributor/supplier that provided merchandise to the retailer. The system disclosed herein is useful in its ability to handle incoming data from any market participant (retailer, supplier, or other middleman) in whatever format that market participant chooses to use. The computer program, system and method disclosed and claimed herein accepts data from any electronic system that is accessible, places the data in a standardized format independently of any particular accounting program, and sends the data out to the appropriate recipient in whatever format that recipient prefers.

One useful component of the data formatting engine is that the trading partners on either side of the transaction can send all of their data in one transmission for parsing, reformatting, and distribution to multiple recipients on the other side of the transaction. The computerized system ensures that the proper recipient receives only that portion of the data that it should receive and in a format that is immediately acceptable by the recipient's own computer system.

### BRIEF DESCRIPTION OF THE FIGURES

FIG. 1 is a block diagram illustrating the data flow according to the invention herein in a retail sales environment between a supplier of merchandise and a retailer receiving the goods.

FIG. 2 is an illustration showing data flows of the prior art between multiple wholesalers communicating with multiple retailers.

FIG. 3 is an illustration showing aggregated data flow, according to this invention, between multiple wholesalers communicating with multiple retailers.

FIG. 4 is an illustration of a sample spreadsheet of parsed data in standardized format according to the teachings of the invention disclosed herein.

FIGS. 5-7 are illustrations of the dashboards used to aggregate and transmit data according to the teachings of the invention disclosed herein.

### DETAILED DESCRIPTION OF THE INVENTION

The invention herein meets a current need in the sales industry, particularly in the realm of retailers and associated suppliers, by providing a computer program, system, and computerized method of formatting data exchanged between trading partners.

Certain terms in this description are used to explain how the invention functions in practical applications but should not be considered limiting of the scope of the invention. For example, the invention is useful in any sales environment whether it is goods or services being exchanged. The term, “sales environment,” includes any commercial undertaking in which one party pays consideration for another party to provide goods or services. Accordingly, the invention encompasses, but is not limited to, sales environments in which retailers sell goods to the public. The term “retailer” includes any vendor selling goods or services in the marketplace. Most retailers order stock from suppliers, a.k.a. wholesalers and distributors. In certain transactions, there may be other middlemen or intermediaries between original supplier and ultimate retailer. The data formatting aspects of the invention claimed herein are applicable to any transaction in which participants in the supply and demand chain need to exchange electronic information. To account for the varying numbers of intermediaries in any given transaction, this detailed description refers to each commercial entity as a “market participant” or a “trading partner.”

Market participants exchanging consideration for goods and services typically interact by exchanging electronic data. This electronic data is generally referred to as “sales data.” Sales data then includes, but is not limited to, purchase order records detailing a retailer's request for goods as well as invoice records by which a supplier expects to be paid for providing the goods to the retailer. Each of these terms described above should be interpreted in a manner that results in the broadest meaning to the claims below.

The computer program, claimed below as a system and computerized method, (referred collectively as “the program (10)”), aggregates discrete sales data records, particularly purchase order records and invoice records, sorts each so that the records are grouped for the appropriate destination, and transmits the correct portion to the appropriate end-user. The computer program (10) is capable of receiving data in any format and processes that data outside of any particular computer accounting system or database. By manipulating the data independently of other record-keeping software, the program (10) is more flexible and easily adapted to any number of market participants' specialized systems.

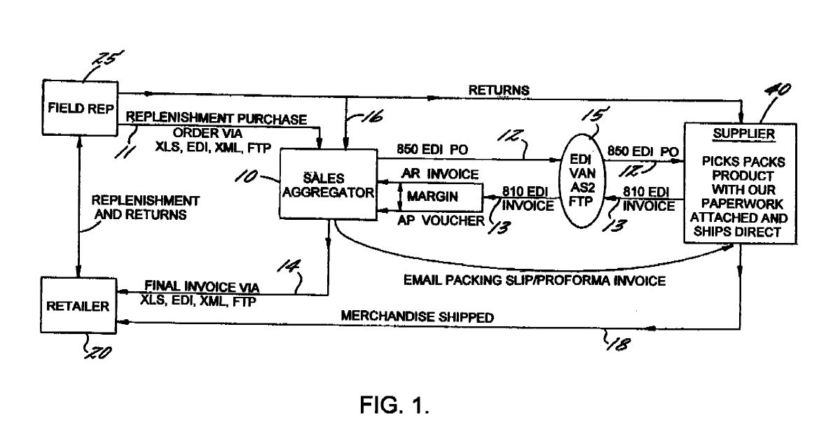

FIG. 1 shows a block diagram embodying one aspect of this invention within a standard supply and demand chain in a retail environment. A retailer (20) typically sells goods that must be replenished over time. Field representatives (25) for various suppliers (40) check on the stock available at each retailer (20) and create purchase orders (11) to restock shelves. These purchase orders (11) will ultimately be fulfilled by any number of suppliers (40). In this system, a field representative (25) may check the shelves of any number of retailers (20), each having their own data formats for electronic communications. Accordingly the field representative (25) will send purchase orders (11) for diverse goods to be shipped by multiple suppliers (40) to multiple retailers (20). The suppliers (40) each have their own preferred electronic data format as well. It is common that the retailers (20) and suppliers (40) do not necessarily use the same data format for transmitting sales data.

The computer program, system, and computerized method disclosed herein provide an intermediate processing functionality by which any incoming data format can be converted to the appropriate outgoing data format. The system, therefore, is capable of ensuring that market participants at any point in the supply and demand chain receive data that is formatted for each respective market participant's situation. The data can also include mixed content within a single transmission. In the example given above, the field representative (25) enters orders for myriad goods to be placed on the shelves at different retail establishments. These goods must be ordered from an equal number of diverse suppliers (40).

In processing the orders on behalf of the retailers (20), the field representatives (25) waste a good deal of time sorting the different items by supplier. The sales aggregator (10) allows the field representatives (25) to send the orders sequentially in any sequential order via any transmission protocol. In this way, the sales aggregator (10) receives line after line of data from a field representative (25), and the data includes diverse purchase order information for different goods to be sent to various suppliers. The ordered goods then need to be shipped to numerous retailers. One fundamental aspect of the sales aggregator (10) is its ability to accept data from any market participant in any transmission format (e.g., EDI, VAN, AS2, FTP, XML) and sort that data so that purchase orders (12) with individualized listing of orders go to the correct supplier.

A parallel process occurs in the reverse direction. The same receipt, sorting, and transmission occurs in regard to invoices (13) going to the appropriate retailer (20). In this direction, the supplier (40) no longer needs to sort its invoices (13) for each and every product going to each and every retailer (20). The sales aggregator (10) accepts data in any transmission format and in whatever grouping or order is convenient for the supplier (40). The sales aggregator (10) provides a single point at which diverse data intended for multiple recipients can be re-formatted according to the recipient's protocol. The recipients receive only the data relevant to them and in a format that the recipient can use.

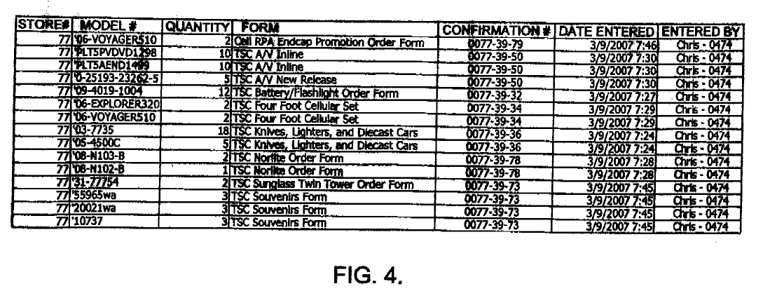

To further illustrate a standard application of the design shown in FIG. 1, another example scenario is useful. A third party service representative (25) enters a retail establishment (20), arranges products on the shelf, and writes a replenishment order (11) for goods. The order may be for several different vendors' products including, for example, a souvenir line, an audio and video line, and cell phone accessories. In this example, the service representatives (20) use web site forms to order each product line. One problem lies in the fact that the field representative's website form is most likely incompatible with the suppliers' in-house system because the data types do not match. Even if the field representative (25) uses a single data entry form, the data is most likely entered as the field representative (25) works and not by supplier (20) identification. See FIG. 4. the program (10) parses and sorts the data to create now data packets that are individualized to each market participant.

The program (10) of this invention accepts each of the field representative's web forms with no absolute requirement of a particular data format or any sorting. The program (10) translates the incoming sales data to a standardized format, typically a database or a spreadsheet. The web forms that the field service representatives (25) send to the program may contain any number of data fields. Typical data fields, as shown in FIG. 4, include the store number, the model number for goods ordered, quantity of goods ordered, the date and time, and the representative who placed the order. The program parses the incoming data and places that in the standardized database format. The data parsing step includes recognizing the format of a data stream from a particular source and mining that data stream for individualized data. The individualized data is then reconfigured into a standardized database.

One field in the standardized database typically indicates which recipient should ultimately obtain the data transmission. For example, in one embodiment, the field service representative (25) uses a particular type of web form, and the program detects the type of form used and recognizes the intended recipient of the data, usually a supplier (40). The program (10) is also loaded with information regarding the preferred data format for the recipients. In this way, the program (10) translates the data into the recipient's preferred format before transmission. All of this data manipulation occurs outside of any particular computer accounting system or record-keeping database.

The sales aggregator (10) receives the replenishment purchase order (11) from the field representative (25), parses the data from its native format, and reconfigures the data from the field representative into a standardized database. As noted in FIG. 1, the sales aggregator includes computer-controlling commands to reconfigure data from the standardized database into the format expected by data processing system at the supplier (40). As shown in FIG. 1, line (18), the supplier (20) ships the merchandise to the retailer (20) in response to the purchase order (12), which has been translated from its native format to a standardized database and into the supplier's format.

After shipping the requested merchandise to the retailer (20), the supplier (40) must send an invoice (14) to the retailer (20). Unfortunately, the invoice (14) will be generated in the supplier's data format, which is not necessarily compatible with the retailer's data format. To solve this problem, the sales aggregator (10) provides a computerized method and system of converting the supplier's invoice (13) into a standardized database format and then generating a final invoice (14) in the retailer's preferred data format.

The system of FIG. 1 also accounts for merchandise returns from retail purchasers. Damaged products or products that the purchaser has decided not to keep are stored at the retailer (20) until the field representative (25) ships the returned items back to the supplier (40) for a credit.

Block (15) of FIG. 1 shows that the data format at any step may be numerous types known in the art. The data transmission types shown in FIG. 1 are merely examples.

In a modification of the process set forth in FIG. 1, the sales aggregator (10) may be configured to accept returns data from the field representative (25), as shown in the dotted line (16). In this scenario, the sales aggregator (10) intercepts data regarding merchandise that purchasers return to the retailer (20). The sales aggregator (10) then includes those returns as a credit on the outgoing final invoice (14) to the retailer (20).

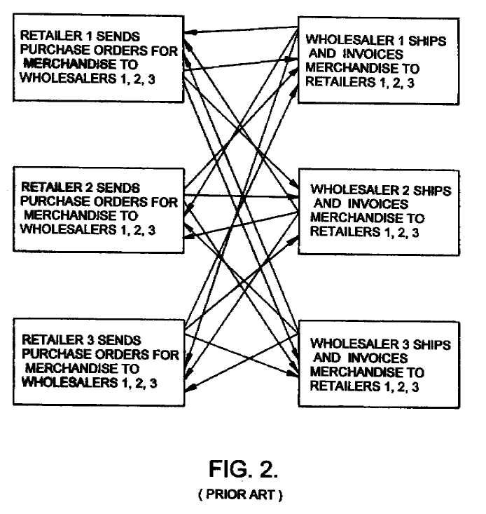

FIG. 2 shows a prior art sales data flow between multiple retailers (20) and multiple wholesalers, or suppliers (40), providing goods for the retailer (20). In each case the various retailers (20) must send data to all of the suppliers (40) to place purchase orders with the supplier. In return, each supplier (40) must send an invoice to each retailer (20) separately. The result is a good deal of overlap among the market participants and wasted data manipulation, especially considering that each market participant potentially has its own preferred format for electronic data transmission.

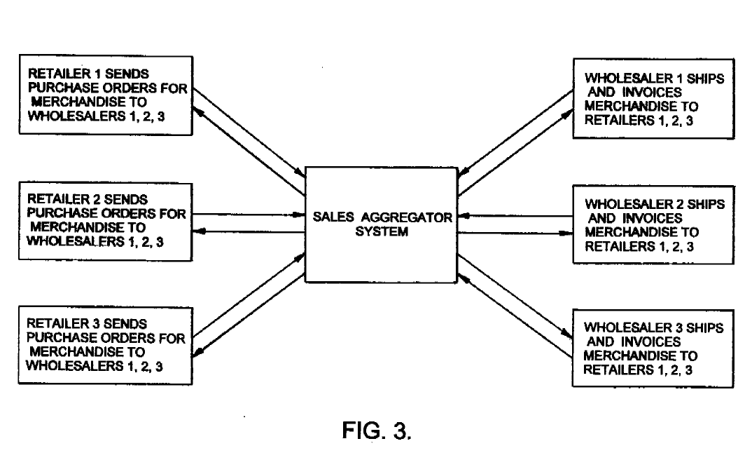

By using the program (10) claimed herein, the supply and demand chain in a retail environment looks more like FIG. 3. Each market participant communicates with the program of this invention and can do so by transmitting data in any convenient format, so long as the program can translate the data to a standardized configuration, such as a database or spreadsheet. As shown in FIG. 3, the retailer (20) can send purchase orders in any format to the program (10), and the program (10) will transmit the purchase order data in the appropriate format to the right supplier/wholesaler (40). In return, the supplier (40) submits invoice data in its raw or native format, and the program translates the data for submission to the appropriate retailer in that retailer's preferred format. The result is a much cleaner data flow and minimal inconvenience to each market participant.

To accomplish the streamlined data flow of FIGS. 1 and 3, one embodiment of the invention is a computer program product (10) in data communication with a computer accounting system to aggregate and manage purchase orders and invoices in a sales environment. The computer program is set forth in a computer readable storage medium having sales aggregator commands thereon, the sales aggregator commands being executable by a processor.

The term sales aggregator refers to that portion of computer code or computer programming that ultimately analyzes incoming sales data, such as purchase order records or invoice records and then sorts that data for transmission to the appropriate party. The aggregator includes a translator command sequence for placing sales data into a standardized format, wherein the translator command sequence operates independently of the computer accounting system or any other database.

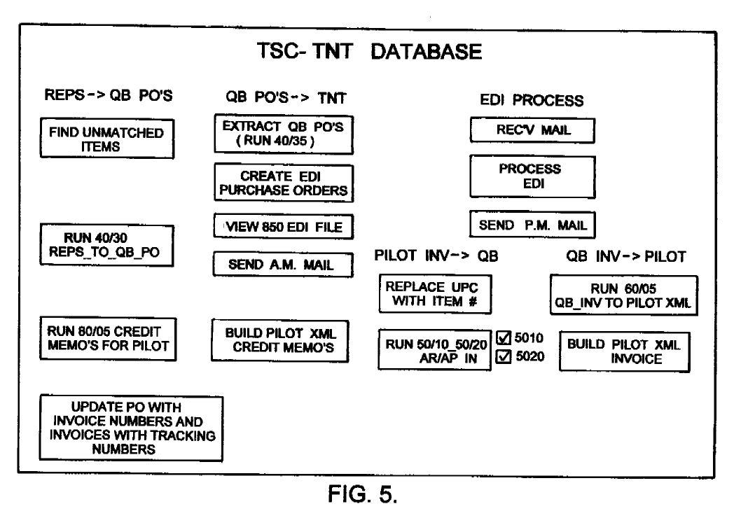

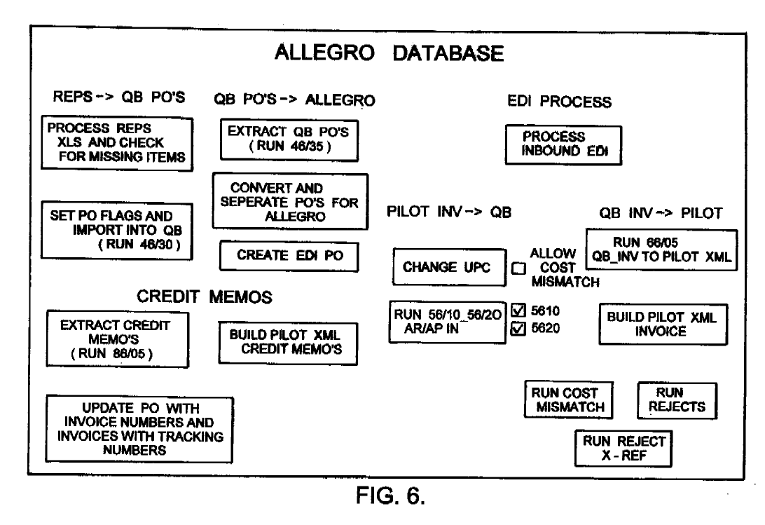

To take advantage of the sales aggregator functionality, the user accesses at least one “dashboard” for consolidating and transmitting all sales data directed to a respective market participant. As used herein, the term “dashboard” refers to a computer screen, such as any one of FIGS. 5-7, that provides a convenient point and click method of accessing the functions of the program claimed herein. Each market participant may have its own “dashboard” for processing data in a user-friendly environment. By selecting one button on the dashboard, an operator can implement the appropriate portion of the computer program to access that market participant's data and convert it accordingly. Each respective dashboard utilizes the translator to place sales data in the respective market participant's preferred format. Another click transmits the data to the appropriate end user.

The program of this invention is particularly useful in its ability to accept multiple purchase orders from multiple vendors, such as large retailers (20). The multiple orders may be included in a single download of data from the vendor (20) to the supplier (40). In this embodiment, the data download may include purchase orders for diverse supplies and stock, each of which should be directed to any number of suppliers. See FIG. 4. The program (10) includes an order input command sequence to accept these multiple orders from at least one vendor, or retailer (20) for goods shipped from at least one supplier (40). In many cases, the orders will come in one batch for multiple retailers seeking goods from multiple suppliers.

To process the multiple types of sales data such as numerous purchase orders in one data download, the program (10) includes a translator command sequence having purchase order subroutines and invoice subroutines. The purchase order subroutine has a supplier identification sequence for analyzing a purchase order in standardized format and determining which supplier (40) should receive the order for fulfillment. In the reverse transaction, the program can accept invoices from suppliers (40) who provided goods to retailers. The invoice subroutines may have a retailer identification sequence to analyze sales data and determine which retailer should receive the invoice for each specific order filled by a supplier. The invoice subroutines add a profit margin to the supplier invoice before transmitting the invoice to the retailer for payment. In this sense, the supplier sends an invoice accounts payable voucher to the program, and the program sends a final invoice with the profit added to the retailer.

As noted above, the program has the capability of accepting data in many different electronic formats so long as the data can be extracted, parsed, and imported into a standardized format such as a database or spreadsheet. The program of this invention interacts with separate data toolkits to extract information from incoming data streams. For example if the incoming data stream includes data from the accounting program known as QuickBooks®, the toolkits known as DFM/Atandra and QODBC/FlexQuarters allow the user to parse the data stream. Similarly, if either a retailer or a supplier requires an EDI transaction, commercially available products such as PROEDI allow the user to convert the standardized data created in the program to the EDI version that the market participant requires. Other market participants may require a value added network protocol and the program can just as easily comply with that request.

As an aside, DFM contains easily identified transactions such as “purchase order” and “invoice” that allow the user to “import” and “export” entire documents from a variety of sources without writing code for a computer program. DFM moves data into and out of QuickBooks® via Microsoft ACCESS® and ODBC. QODBC, on the other hand, uses Microsoft ACCESS® to link to the QuickBooks® database for raw access to the tables. With QODBC, a user has to know that, in order to get a complete purchase order record, the program must link to tables that contain different information regarding the purchase order.

In another embodiment, the invention is a computer program product in data communication with a computer accounting system to aggregate and manage multiple merchandise orders from retailers (20). The product includes a computer readable storage medium having aggregator commands better executable by a processor. The aggregator commands incorporate a translator command sequence for placing orders into a standardized data format, such as a database or spreadsheet. The translator command sequence operates independently of the computer accounting system and includes incoming order processing routines and outgoing order processing routines. The incoming orders may include individual records showing multiple products that a retailer would like to re-stock, but the records are in no particular order and are not grouped according to the supplier that will actually shipped the products. The incoming orders are simply record after record showing diverse quantities of requested goods from any number of locations. The aggregator of this invention accepts this raw data in any format, converts the data to a more usable type, and ensures that each record gets to the appropriate supplier and orderly fashion.

To accomplish the goals of accepting diverse data in any format and organizing it to a supplier's preferences, the program (10) includes a supplier identification sequence that analyzes the orders and determines which supplier (40) should receive them. Again, the user can access a supplier dashboard to aggregate all orders that should be fulfilled by a respective supplier and to transmit those orders accordingly. The dashboard also accesses the program's outgoing order processing routines to place the purchase orders in the supplier's respective format.

Of course, after filling in order, a supplier (40) expects to be paid by the retailer (20). To ensure that the supplier's invoice is in a format that the retailer's system can use, the supplier (40) sends raw data to the program (10) described herein. The computer program product of this invention includes a translator command sequence having incoming invoice processing routines and final invoice processing routines. A retailer identification sequence analyzes the incoming invoice record from a supplier after that record has been translated into a standardized data format. The retailer desiccation sequence determines which retailer should receive the invoice for payment. The computer program product utilizes the dashboard scheme shown in FIGS. 5-7 for aggregating all invoice records to be directed to a respective retailer and transmitting aggregate invoice records accordingly. The dashboard also give a user access to final invoice processing routines within said translator to place the invoice and a respective retailer's preferred format for incoming data. The final invoice processing routines also add any profit margin to the invoice before transmitting invoice to the retailer.

The computer program product accesses peripheral computer functions that also add extra levels of convenience to the user. For example, the program accesses an electronic mail system to forward a packing slip to the supplier for which an order has been process. This packing slip can be included with the shipped goods that go directly to the retailer.

The computer program and the associated product of this invention implements a method of aggregating a multitude of purchase orders or invoice records for consolidation and transmission to an appropriate market participant. The steps of the method include (i) receiving sales data from a market participant; (ii) converting the sales data to a standardized format that is independent of any particular computer accounting system (iii); (iv) parsing the sales data into discrete portions and importing that data into particular fields associated with a standardized format; (v) identifying other market participants that should each receive respective discrete portions of the sales data; (vi) determining the preferred data format for each respective market participant receiving portions of sales data; (iv) and transmitting portions of sales data to the appropriate market participant in the preferred format.

In implementing the method of this invention, the program receives data streams retailers or their representatives that must be converted to other formats before transmission the appropriate supplier. Conversely, the program receives invoice records from a supplier (40) that must be converted to the retailers' desired formats. The program utilizes the functions described above to parse the sales data (invoice or purchase records) and places each discrete portion in an appropriate field in a database. Certain key fields in the database alert the user to the fact that the data should be transmitted to an appropriate retailer or supplier. For instance, the form type in which the data arrives often indicates that the record came from a certain retailer and should be sent to a specific supplier. Other data in other fields can also be used to identify the origination and destination of the data.

Overall, the program of this invention can accept sales data in whatever order and any format recognized or readable by the program (10). The step of aggregating the sales data occurs after the step of determining the preferred format but before the step of transmitting the sales data to its intended recipient. By aggregating like sales records, the program lists all purchase order or invoice records from a respective retailer or supplier (40) so the documentation is concisely and systematically transferred to the appropriate place without duplication.

### EXAMPLE 1

An example is useful in further illustrating the functions of the program of this invention. FIG. 4 shows a spreadsheet in which incoming data in any format has been parsed and placed in a standardized format that includes fields for the retailer store number, the model number of the item being ordered, the quantity, the form in which the order arrived, the confirmation number, the date entered, and the representative that entered the purchase order records. The appropriate recipient of the data, whether the data represents a purchase order or an invoice, may be determined visually by the Form field or automatically by the program identifying characteristic data for a particular market participant. By identifying the desired recipient, the program brings up the right dashboard to process the data in the recipient's preferred format. The dashboard includes user screens that import and export data as well as manipulate the data format by running combinations of code, macros, or functions from a peripheral toolkit. Operations from the dashboard are governed by the direction of data movement, i.e. the origination and the destination.

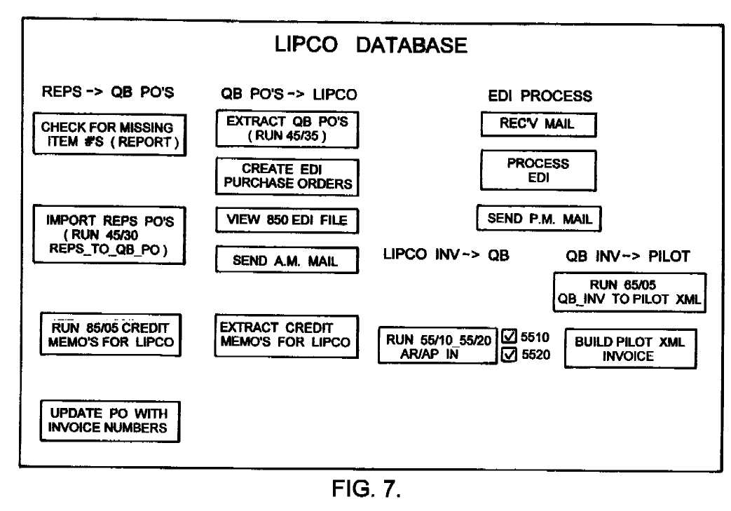

The dashboard has multiple buttons for selecting the processing that should be performed on the data once the data is in a non-accounting based standard format. For instance, In FIG. 7, one of the buttons on the dashboard is entitled Missing Items. This button runs a program that uses the QODBC links to a Quickbooks database to validate the items being ordered and confirm that the items are legitimate for this retailer. Referring to FIG. 4, the first thing the button does is remove the apostrophe prefix from each model number entry. Next, the program extracts the Quickbooks item master table to a local Access table and validates the model number from a list of model numbers that the retailer has provided.

The dashboard offers several options for processing data. One macro that should be run on the data of FIG. 4 is shown by the entries in rows 3 and 4 of that spreadsheet. The “PLT” prefix in the model number indicates that each of the purchase orders in rows 3 and 4 are audio/video items that are shipped as a mix of variously priced materials. The “PLT” model number is the retailer's SKU. That SKU needs to be converted to a UPC code for the supplier (40) to process the purchase order. The program has access to a supplier's UPC table that will provide the appropriate UPC for each of rows 3 and 4 before the purchase order is transmitted to a supplier.

Other data items shown in FIG. 4 are manipulated to address technicalities in the format. For example, the fifth row contains an audio/video new release. The model number column contains the appropriate UPC already, but the dashes must be removed for the supplier's system to accept the data. A similar correction occurs in rows 14 and 15. These rows include purchase orders for souvenirs with a state imprint for Washington. The souvenirs must be ordered with the state suffix WA but invoiced to the retailer without the suffix. The program quickly and efficiently corrects the data to address these formatting problems.

The figures attached hereto and described above show a number of currently used protocols for data formatting and data transmission. For example, a replenishment order from a retailer may be sent to the program in XLS, EDI, or XML via the AS2 or FTP transfers. The same protocols are used in sending electronic invoices to the retailer after the retailer receives the goods. Furthermore, as shown in FIG. 1, purchase order forms are often, but not always, sent to the suppliers in EDI formats. These references are for illustration only and are not limiting of the invention claimed below.

The present invention has been described with reference to the accompanying illustrative figures, in which various embodiments of the invention are shown. This invention may, however, be embodied in many different forms and should not be construed as limited to the embodiments set forth herein; rather, these embodiments are provided so that this disclosure of the present invention will be thorough and complete, and will fully convey the scope of the invention to those skilled in the art. Although specific terms are employed herein, they are used in a generic and descriptive sense only and not for purposes of limiting the scope of the present invention as defined by the attached claims in any way. Some terminology will be defined herein and used to describe forthcoming embodiments of the present invention, in order to teach the present invention to those skilled in the art. The invention is further set forth in the claims below.

1. A computer program product in data communication with a computer accounting system to aggregate and manage purchase orders and invoices in a sales environment, comprising:
a computer readable storage medium having sales aggregator commands thereon, said sales aggregator commands being executable by a processor and comprising:
a translator command sequence for placing sales data into a standardized format, wherein said translator command sequence operates independently of the computer accounting system; and
at least one dashboard for aggregating and transmitting all sales data directed to a respective market participant, said dashboard utilizing said translator to place said sales data in the respective market participant's preferred format.

2. A computer program product according to claim 1, further comprising an order input command sequence for accepting multiple orders from at least one vendor, said orders to be fulfilled by at least one supplier.

3. A computer program product according to claim 1, wherein said market participant is selected from the group consisting of retail vendors, wholesale merchandise suppliers, and middlemen.

4. A computer program product according to claim 1, wherein said sales data comprise either a purchase order for deliverable goods or an invoice for supplied goods.

5. A computer program product according to claim 1, wherein said translator command sequence comprises purchase order subroutines and invoice subroutines.

6. A computer program product according to claim 5, wherein said purchase order subroutine comprises a supplier identification sequence for analyzing a purchase order in standardized data format and determining which supplier should receive said order for fulfillment.

7. A computer program product according to claim 6, wherein said dashboard aggregates all purchase orders to be fulfilled by a respective supplier and transmits said aggregated orders to the respective supplier in that supplier's preferred format.

8. A computer program product according to claim 5, wherein said invoice subroutine comprises a retailer identification sequence for analyzing sales data in standardized data format and determining which retailer should receive an invoice for orders fulfilled by a supplier.

9. A computer program product according to claim 8, wherein said dashboard aggregates all invoice records for orders fulfilled by a respective supplier and transmits said aggregated invoices to the respective retailer in that retailer's preferred format.

10. A computer program product according to claim 9, wherein said invoice subroutine adds a profit margin to the supplier invoice before transmitting the invoice to the retailer for payment.

11. A computer program product according to claim 1, wherein said translator command sequence interacts with a separate data toolkit to extract data from an incoming purchase order or from an incoming invoice.

12. A computer program product according to claim 1, wherein said sales data comprises an EDI protocol.

13. A computer program product according to claim 1, wherein said sales data comprises a VAN protocol.

14. A computer program product in data communication with a computer accounting system to aggregate and manage multiple merchandise orders from retailers, comprising:
a computer readable storage medium having order aggregator commands thereon, said order aggregator commands being executable by a processor and comprising:
a translator command sequence for placing said orders into a standardized data format, wherein said translator command sequence operates independently of the computer accounting system and comprises incoming order processing routines and outgoing order processing routines;
a supplier identification sequence for analyzing said order in said standardized data format and determining which supplier should receive said order for fulfillment;
a supplier dashboard for aggregating all orders to be fulfilled by a respective supplier and transmitting said aggregated orders to the respective supplier, said dashboard utilizing said outgoing order processing routines of said translator to place said order in the respective supplier's format.

15. A computer program product according to claim 14, wherein said translator command sequence further comprises incoming invoice processing routines and final invoice processing routines.

16. A computer program product according to claim 15, further comprising a retailer identification sequence for analyzing an incoming invoice record from a supplier that has been translated into said standardized data format and determining which retailer should receive said invoice for payment.

17. A computer program product according to claim 16, further comprising a retailer dashboard for aggregating all invoice records to be directed to a respective retailer and transmitting said aggregated invoice records to the respective retailer, said dashboard utilizing said final invoice processing routines of said translator to place said invoice in the respective retailer's preferred format.

18. A computer program product according to claim 17, wherein said final invoice processing routines add a profit margin to the invoice before transmitting the invoice to the retailer.

19. A computer program product according to either claim 3 or claim 14 that interacts with an electronic mail system to forward a packing slip to the supplier for inclusion with the fulfilled order that is shipped out.

20. A computer program product according to either claim 1 or claim 14, wherein said standardized format is a database.

21. A computer implemented method of aggregating a multitude of purchase orders or invoice records for consolidation and transmission to an appropriate market participant, comprising:
receiving sales data from a market participant;
converting the sales data to a standardized format that is independent of any particular computer accounting system;
parsing said sales data into discrete portions;
identifying other market participants that should each receive respective discrete portions of the sales data;
determining the preferred data format for each respective market participant receiving the portions of sales data;
transmitting the portions of sales data to the appropriate market participant in the preferred format.

22. A computer implemented method according to claim 21, wherein the step of receiving sales data comprises receiving a multitude of merchandise purchase order records from at least one retailer for submission to at least one supplier.

23. A computer implemented method according to claim 21, wherein the step of receiving sales data comprises receiving a multitude of merchandise invoice records from at least one supplier for submission to at least one retailer.

24. A computer implemented method according to claim 23, wherein the step of parsing the sales data comprises placing discrete portions of the sales data in appropriate fields in a database.

25. A computer implemented method according to claim 24, wherein at least one discrete portion of the sales data identifies the market participant that should receive the sales data.

26. A computer implemented method according to claim 23, further comprising the step of adjusting the content of the sales data after determining the preferred format for the receiving market participant.

27. A computer implemented method according to claim 23, further comprising the step of aggregating all sales data that should be sent to a respective market participant in a single batch, wherein the aggregating step occurs after the step of determining the preferred format but before the step of transmitting the sales data.

28. A computer implemented method according to claim 27, wherein the aggregating step comprises listing all purchase order records from a single retailer for goods to be supplied by a single wholesale distributor.

29. A computer implemented method according to claim 27, wherein the aggregating step comprises listing all invoice records from a single supplier for goods that have been shipped to a single retailer.

30. A computer implemented method according to claim 23, wherein the step of receiving sales data comprises receiving the data in a format selected from the group consisting of accounting data, EDI data, and VAN data.

31. A computer implemented method according to claim 23, wherein the step of transmitting the data comprises utilizing a transmission method selected from email, AS2, and FTP.

32. A computer implemented method according to claim 23, wherein the step of receiving sales data comprises receiving data from a retailer regarding merchandise that has been returned by a purchaser.
